(19) United States
(12) Patent Application Publication
(10) Pub. No.: US 2003/0118888 A1
(43) Pub. Date: Jun. 26, 2003

(54) Polymer coated metallic bipolar separator plate and method of assembly

(75) Inventor: Jeffrey Peter Allen, Naugatuck, CT (US)

Correspondence Address: BANNER & WITCOFF, LTD., 28 STATE STREET, 28th FLOOR, BOSTON, MA, 02109, US

(73) Assignee: GenCell Corporation, Southbury, CT

(21) Appl. No.: 10/310,351

(22) Filed: Dec. 5, 2002

Related U.S. Application Data
(60) Provisional application No. 60/337,610, filed on Dec. 5, 2001.

(51) Int. Cl. H01M 8/02; H01M 8/10; B05D 5/12; H01M 8/24

(52) U.S. Cl. 429/34; 429/32; 427/115; 429/35; 429/38; 429/30; 428/462

(57) ABSTRACT

A fuel cell bipolar separator plate at least partially coated with a coating that is stable when in contact with or in close proximity to a proton exchange membrane and that is stable within the environment of the anode and cathode environments of the fuel cell is provided. Also included are fuel cells comprising such a fuel cell bipolar separator plate and method of manufacturing the fuel cell bipolar separator plate and the fuel cell comprising the fuel cell bipolar separator plate.

### CROSS-REFERENCE TO RELATED APPLICATIONS

This application claims priority to Provisional Patent Application No. 60/337,610, filed Dec. 5, 2001.

### FIELD OF INVENTION

The invention relates to low temperature fuel cells and fuel cell bipolar separator plates and to methods for applying coatings to bipolar separator plates for the purpose of encapsulation of the metallic substrate of the bipolar separator plate and to methods of assembly of coated metallic bipolar separator plates.

### BACKGROUND OF THE INVENTION

A fuel cell stack consists of multiple planar cells stacked upon one another, to provide an electrical series relationship. Each cell is comprised of an anode electrode, a cathode electrode, and an electrolyte member. A device known in the art as a bipolar separator plate, an interconnect, a separator, or a flow field plate, separates the adjacent cells of a stack of cells in a fuel cell stack. The bipolar separator plate may serve several additional purposes, such as mechanical support to withstand the compressive forces applied to hold the fuel cell stack together, providing fluid communication of reactants and coolants to respective flow chambers, and to provide a path for current flow generated by the fuel cell. The plate also may provide a means to remove excess heat generated by the exothermic fuel cell reactions occurring in the fuel cells.

Prior art bipolar separator plates have typically been produced in a discontinuous mode utilizing highly complex tooling that produces a plate with a finite cell area. Alternatively, prior art plates having a finite area may be produced from a collection of a mixture of discontinuously and continuously manufactured sheet-like components that are assembled to produce a single plate possessing a finite cell area. U.S. Pat. No. 6,040,076 to Reeder teaches an example of a Molten Carbonate Fuel Cell (MCFC) bipolar separator plate produced in this fashion, where plates are die formed with a specific finite area of up to eight square feet. U.S. Pat. No. 5,527,363 to Wilkinson et. al. teaches an example of a Proton Exchange Membrane Fuel Cell (PEMFC) “embossed fluid flow field plate,” also die formed with a discrete finite area. U.S. Pat. No. 5,460,897 to Gibson et. al. teaches an example of a Solid Oxide Fuel Cell (SOFC) interconnect, also produced having a finite area. Bipolar separator plates produced with a discontinuous finite area do not enjoy the advantages of continuous production methods such as are commonly used to produce the electrodes and electrolyte members of the fuel cell. Continuous production methods provide cost and speed advantages and minimize part handling. Continuous production using what is known as progressive tooling allows the use of small tools that are able to produce large plates from sheet material. The plate described in Reeder is able to be produced in a semicontinuous fashion, but requires tooling possessing an area equivalent to that of the finished bipolar plate area. The plate described in Reeder requires separately produced current collectors for both the anode and cathode. These current collectors may be produced in a continuous fashion. However, the resultant assembly is material intensive, comprised of three sheets of material. The area of the plate created by the design is fixed and unalterable unless retooled. Production methods that utilize molds to produce plates from non-sheet material, such as injection molding with polymers, are wholly unable to stream the production process in a continuous mode. As a result, discontinuous production methods require complex tooling and are speed limited. Complex tooling further inhibits design evolution due to the costs associated with replacing or modifying the tools.

While carbon graphite, polymers, and ceramics are common examples of the materials of choice for the bipolar separator plate of the various fuel cell types, sheet metal can also be found as an example of the material of choice for each of the fuel cell types in the prior art literature. For example, Reeder teaches a metallic MCFC bipolar separator plate. U.S. Pat. No. 5,776,624 to Neutzler teaches a metallic PEMFC bipolar separator plate. Gibson teaches a metallic SOFC bipolar separator plate. U.S. Pat. No. 6,080,502 to Nolscher et. al. teaches a metallic bipolar separator for fuel cells and denotes fuel cells as including Phosphoric Acid Fuel Cell (PAFC) and Alkaline Fuel Cell (AFC). Sheet metal, or metal foil, permits the application of high-speed manufacturing methods such as continuous progressive tooling. Metallic bipolar separator plates for fuel cells further provide for high strength and compact design.

Polymer electrolyte membrane or proton exchange membrane (PEM) fuel cells are particularly advantageous because they are capable of providing potentially high energy output while possessing both low weight and low volume. Each such fuel cell comprises a membrane-electrode assembly comprising a thin, proton-conductive, polymer membrane-electrolyte having an anode electrode film formed on one face thereof and a cathode electrode film formed on the opposite face thereof. In general, such membrane-electrolytes are made from ion exchange resins, and typically comprise a perfluorinated sulfonic acid polymer such as NAFION™ available from E. I. DuPont DeNemours & Co. The anode and cathode films typically comprise finely divided carbon particles, very finely divided catalytic particles supported on the internal and external surfaces of the carbon particles, and proton-conductive material intermingled with the catalytic and carbon particles, or catalytic particles dispersed throughout a polytetrafluoroethylene (PTFE) binder.

NAFION membranes are fully fluorinated TEFLON™-based polymers with chemically bonded sulfonic acid groups that promote the transport of hydrogen ions during operation of the fuel cell. The membranes exhibit exceptionally high chemical and thermal stability. However, some metallic alloys that are commercially and economically viable candidates for PEM applications may be subject to corrosion if the alloy comes into contact with NAFION membrane material. This corrosion of metallic foil results in the subsequent liberation of corrosion product in the form of metallic ions, such as Fe, that may then migrate to the proton exchange membrane and contaminate the sulfonic acid groups, thus diminishing the performance of the fuel cell.

U.S. Pat. No. 5,858,567 to Spear, Jr. et al. teaches a separator plate comprised of a plurality of thin plates into which numerous intricate microgroove fluid distribution channels have been formed. These thin plates are then bonded together and coated or treated for corrosion resistance. The corrosion resistance of Spear, Jr. et al. is brought about by reacting nitrogen with the titanium metal of the plates at very high temperatures, for example between 1200° F. and 1625° F., to form a titanium nitride layer on exposed surfaces of the plate.

European Patent No. 0007078 to Pellegri et al. teaches a bipolar separator for use in a solid polymer electrolyte cell that is comprised of an electrically conductive powdered material, for example graphite powder and/or metal particles, mixed with a chemically resistant resin, into which an array of electrically conductive metal ribs are partially embedded. The exposed part of the metal ribs serves to make electrical contact with the anode. The entire surface of the separator, with the exception of the area of contact with the anode, is coated in a layer of a chemically resistant, electrically non-conductive resin. The resin can be a thermosetting resin such as polyester, phenolics, furanic and epoxide resins, or can be a heat resistant thermoplastic such as halocarbon resins. This resin coating layer serves to electrically insulate the surface of the separator. The separator is produced by pressure molding the electrically conductive powder material/resin mixture with the metal rods, applying the coating over the separator, repressurizing the separator in a pressure mold, and machining or buffing the areas of contact with the anode to remove the coating.

Production methods such as this that utilize molds to produce plates from non-sheet material are wholly unable to stream the production process in a continuous mode. As a result, discontinuous production methods require complex tooling and are speed limited. Complex tooling further inhibits design evolution due to costs associated with replacing or modifying the tools.

A need exists for a bipolar separator plate that can be used with proton electrolyte membrane fuel cells without suffering the problems just described. In particular, a need exists for a bipolar separator plate that is comprised of metal foil, to take advantage of the benefits such a material offers for use in a PEM fuel cell, whereby the metal foil separator plate is not susceptible to the corrosive effects of being in contact with or in close proximity to the proton exchange membrane.

### SUMMARY OF THE INVENTION

The novel fuel cell bipolar separator plates of the present invention are at least partially coated with a coating that is stable when in contact with or in close proximity to the proton exchange membrane and that is stable within the environment of the anode and cathode environment of the fuel cell. The coating thereby protects the plate from corrosion, allowing for the manufacture of PEM type fuel cells that take advantage of the benefits of metallic separator plates such as the application of high-speed manufacturing methods including continuous progressive tooling and the high strength and compact design that is made possible by metallic separator plates.

The fuel cell bipolar separator plates preferably comprise metal foils. Bipolar separator plates that are produceable in variable length are described in related Non-provisional U.S. patent application Ser. No. 09/714,526, filed on Nov. 16, 2000, titled “Fuel Cell Bipolar Separator Plate and Current Collector Assembly and Method of Manufacture,” which is incorporated in entirety herein by reference. The plate being constructed from metallic foils is desirable for application to low temperature fuel cells utilizing Proton Exchange Membranes (PEM's). Metallic foils are easily processed with conventional tools to produce the necessary mechanical structure and architecture within the plate. PEM's are comprised of NAFION™ a product of E. I. DuPont De Nemours. NAFION membranes are fully fluorinated TEFLON-based polymers with chemically bonded sulfonic acid groups. The membranes exhibit exceptionally high chemical and thermal stability.

Contact between the metallic alloy separator plate and the PEM is prevented by the application of a coating to the metallic foil comprising the plate. The coating is stable when in contact with or in close proximity to the proton exchange membrane and that is stable within the environment of the anode and cathode environment of the fuel cell. The plate may be coated only at the points of the separator plate that will be in intimate contact with or close proximity to the proton exchange membrane when the plate is incorporated into the fuel cell, or may optionally be entirely coated with the coating, thereby encapsulating the plate. The coating may consist of a polymer that is known to be stable in the presence of NAFION and within the environment of the anode and cathode environments of the fuel cell. The coating may be a polysulphone, a polypropylene, a polyethylene, TEFLON, or other such polymer coating. The coating may be applied by various means known to be effective in the coating of metallic substrates. A preferred embodiment utilizes coating methods commonly utilized in the coating of continuous strips of metal sheets and foils as are commonly applied in the coil coating industry. For example, spray coating, dip coating, roll coating, blown-film coating, cast coating, powder coating, and other methods.

The coating may be applied only to those areas of the metallic foils that comprise the bipolar separator plate that are in intimate contact with, or close proximity to, the NAFION membrane, for example, the seal area at the perimeter of the bipolar separator plate where the membrane forms a seal between adjacent bipolar separator plates that separate adjacent cells in a stack of cells forming a fuel cell stack. The coating may preferably further be applied to the entire area of the metallic substrate comprising the bipolar separator plate to further enhance the encapsulation of the metal. In a preferred embodiment the peaks and valleys comprising the flow channels of the central active area of the bipolar separator plate are coated with a polymer prior to the final forming and assembly of the bipolar plate. However, an electrical contact is required at the interface of the peaks of the flow channels of the plate and the current collector, which is typically comprised of porous carbon fiber paper that is electrically conductive. Therefore, the interface between the peaks of the flow channels of the central active area and the current collector must be conductive.

In certain preferred embodiments, the coating comprises a conductive polymer such that the conductivity of the interface of the polymer-coated peaks and the current collector is achieved without violation of the integrity of the encapsulating polymer coating. In other preferred embodiments, porous carbon fiber paper is bonded, welded, or embedded into and through the polymer coating in such a fashion that it does not violate the integrity of the coating, thus achieving conductivity. The conductivity may in still other preferred embodiments be achieved with an intermediary support element that is bonded, welded, or embedded into and through the polymer coating in such a fashion that it does not violate the integrity of the coating. The intermediary support element may be a screen or a series of wires. The intermediary support element may be comprised of a conductive material that is stable in the presence of the fuel cell environment, as for example carbon graphite fibers or noble metal wires, or fabrics and screens fabricated from said fibers and wires. Where the current collectors are in contact with the separator plate, or where the current collectors are in contact with a conductive intermediary support that is in contact with the separator plate such that electrical contact exists between the current collectors and the separator plate, the coating may be non-conductive, preferably a non-conductive polymer, advantageously a thermal-plastic polymer.

Conductive polymers are well established in the art. Non-conductive polymer coatings are well established in the art and are readily available in various forms. Furthermore, various methods of bonding and welding polymer structures are well established in the art. For example, a bipolar separator plate that is coated with a nonconductive polymer may be joined with the porous carbon fiber paper by means of ultrasonic welding or thermal welding. Welding is better suited to thermal-plastic non-conductive polymers.

In one preferred embodiment of the present invention, the bipolar separator plate receives a coating comprised of a non-conductive thermal-plastic polymer, into which the current collectors are embedded such that they make contact with the separator plate. In certain preferred embodiments, current collectors, optionally porous carbon fiber paper current collectors, are positioned over the central active area of the plate. Heating platens are positioned over the current collectors. A compression device is equipped to apply pressure to the assembly comprising the cathode current collector, plate and anode current collector. Upon activation of the compression device, heat and pressure will be generated at the interfaces between the current collectors and the plate. Optionally, the heating platens may be equipped with ultrasonic generators to provide additional heat and pressure.

Heat and pressure is applied for an amount of time necessary to result in the fibers of the porous carbon fiber current collectors flowing through the polymer coating and contacting the peaks of the flow channels of the plate. Optionally, electrical leads are provided at the cathode current collector, the anode current collector and the separator plate and routed to a pair of ohmmeters, one accepting the leads from the anode current collector and the plate and one accepting the leads from the cathode current collector and the separator plate. The welding operator may observe these ohmmeters to determine when an optimum level of electrical conductivity is achieved at the interfaces.

Upon being exposed to heat and pressure, the polymer coating flows around and encapsulates the fibers of the porous carbon fiber papers comprising the current collectors such that the integrity of the polymer coating is intact, and that the metallic substrate of the plate remains encapsulated and protected from contact with the NAFION comprising the membrane of an assembled cell.

Another preferred embodiment utilizes resistive heating elements within the compressive device, optionally within platens of the compressive device. In this embodiment, heat required to perform the welding is provided from the resistive heaters. Heat is applied until the desired welded bond and the optimum ohmic resistance is achieved, at which point the resistive heaters are turned off and the welded assembly is allowed to cool.

Another preferred embodiment of the polymer coated plate uses the application of similar welding techniques to effect the welding and encapsulation of eyeleted internal fuel manifold openings. Other methods for manufacturing the fuel cell utilizing a coated separator plate will be readily apparent to those of ordinary skill in the art, given the benefit of the present disclosure.

In certain preferred embodiments, the coating serves to enhance the sealing ability of the separator plate, for example an eyeleted joint. Upon being compressed while being heated, the coating, preferably a thermal-plastic coating, flows through the joint and encapsulates the joint area, further sealing the joint.

In a preferred embodiment of the present invention, manufacture of the bipolar separator plate that is to be coated is accomplished by producing repeated finite sub-sections of a bipolar separator plate in continuous mode. The plate may be cut to any desirable length in multiples of the repeated finite sub-section and processed through final assembly, or recoiled for further processing. The structure of the separator plate that creates flow channels and manifolds is stretch-formed into finite sub-sections by what is known in the art as progressive tooling. Progressive tooling is an efficient means to produce complex stampings from a series of low-complexity tools, or, as a means to produce a product whose area is substantially larger than the tool that is utilized. As a result, the bipolar separator plate of the present invention produced in this manner possesses modularity not found in conventional discontinuous bipolar separator plate designs. The scaleable cell area of such a separator plate provides responsiveness to a wider range of fuel cell applications, from residential to light commercial/industrial to automotive, without deviating from the underlying geometries. Though fuel cell stacks clearly are scaleable by altering the quantity of cells comprising the stack of cells, it is advantageous to efficiently alter the area of the cells as well. As is well known in the art, cell count determines stack voltage while cell area determines stack current. Particularly advantageous is the fact that the repeated finite sub-sections of the continuously produced bipolar separator plate do not require discontinuity of the electrodes and electrolyte member of the fuel cell. Many of the conventional designs of the prior art bipolar separator designs are quite capable of continuous, progressively tooled, manufacture. However, all prior art designs would require discontinuity of the electrodes and electrolyte members in order to properly fit the resultant repeated finite sub-sections. Many prior art designs are incapable of continuous progressive tooling due to the nature of their fuel, oxidant, and coolant manifolding and flow pattern designs.

These and additional features and advantages of the invention disclosed here will be further understood from the following detailed disclosure of preferred embodiments.

### BRIEF DESCRIPTION OF THE SEVERAL VIEWS OF THE DRAWING

The aspects of the invention will become apparent upon reading the following detailed description in conjunction with the accompanying drawings, in which:

FIG. 1 illustrates a plan view of the anode side of a partially cut-away bipolar separator plate, current collector, membrane/electrode assembly.

FIG. 2 illustrates a cross-section taken at line AA of FIG. 1.

FIG. 3 illustrates a view taken at BB of FIG. 2.

FIG. 4 illustrates a cross-section taken at line CC of FIG. 1.

FIG. 5 illustrates a sealing fixture.

FIG. 6 illustrates a view taken at FF of FIG. 5.

FIG. 7 illustrates a cross-section of an exploded assembly.

### DETAILED DESCRIPTION OF THE INVENTION

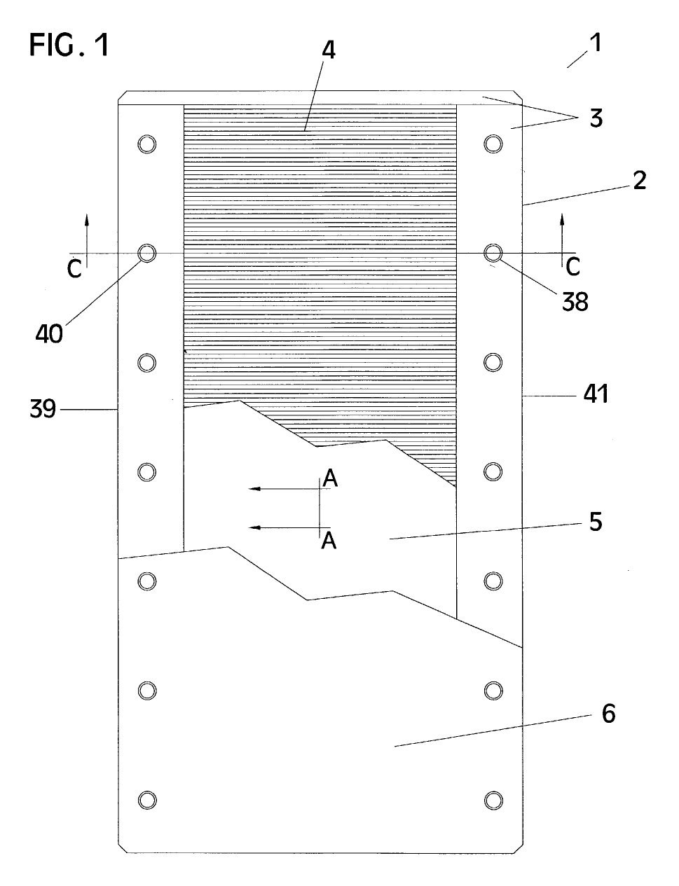

FIG. 1 illustrates a bipolar separator plate that is produceable in variable length as described in related Non-provisional U.S. patent application Ser. No. 09/714,526, filed on Nov. 16, 2000, titled “Fuel Cell Bipolar Separator Plate and Current Collector Assembly and Method of Manufacture” and incorporated in entirety herein by reference. The plate 1 being constructed from metallic foils is desirable for application to low temperature fuel cells utilizing Proton Exchange Membranes (PEM's) 6. Metallic foils are easily processed with conventional tools to produce the necessary mechanical structure and architecture within the plate 1. PEM's 6 are comprised of Nafion™ a product of E. I. DuPont De Nemours. Nafion membranes 6 are fully fluorinated TEFLON-based polymers with chemically bonded sulfonic acid groups. The membranes exhibit exceptionally high chemical and thermal stability. However, some metallic alloys that are commercially and economically viable candidates for PEM applications may be subject to corrosion if the alloy comes in contact with Nafion membrane material. Undesirable corrosion of the metallic foil results in the subsequent liberation of corrosion product in the form of metallic ions such as Fe. Liberated metallic ions may migrate to the membrane 6 and contaminate the sulfonic acid groups that promote the transport of hydrogen ions during operation of the fuel cell thus diminishing performance of said fuel cell.

Contact is preventable by the application of a coating to the metallic foil 2 comprising the plate 1. The coating may consist of a polymer that is known to be stable in the presence of Nafion and within the environment of the anode and cathode environments of the fuel cell. The coating may be a polysulphone, a polypropylene, a polyethylene, TEFLON, or other such polymer coating. The coating may be applied by various means known to be effective in the coating of metallic substrates. A preferred embodiment utilizes coating methods commonly utilized in the coating of continuous strips of metal sheets and foils as are commonly applied in the coil coating industry. For example, spray coating, dip coating, roll coating, blown-film coating, cast coating, powder coating, and other methods.

The coating may be applied only to those areas of the metallic foils that comprise the bipolar separator plate that are in intimate contact with, or close proximity to, the Nafion membrane 6. For example, the seal area 3 at the perimeter of the bipolar separator plate 1 where the membrane 6 forms a seal between adjacent bipolar separator plates that separate adjacent cells in a stack of cells forming a fuel cell stack.

The coating may further be applied to the entire area of the metallic substrate comprising the bipolar separator plate to further enhance the encapsulation of the metal. In a preferred embodiment the peaks and valleys comprising the flow channels of the central active area 4 of the bipolar separator plate 1 are coated with a polymer prior to the final forming and assembly of the bipolar plate. However, an electrical contact is required at the interface of the peaks of the flow channels of the plate 1 and the current collector 5 that is shown partially cut away. The current collector 5 is comprised of porous carbon fiber paper that is electrically conductive. Electric current generated at the reaction sites of the membrane and electrode is gathered by the current collector and transmitted through adjacent cells of a stack of cells to the terminals normally positioned at the ends of the stack of cells. This electronic flow path includes the bipolar separator plate of each cell. Therefore, the interface between the peaks of the flow channels of the central active area 4 and the current collector 5 must be conductive.

The conductivity of the interface of the polymer-coated peaks and the current collector may be achieved without violation of the integrity of the encapsulating polymer coating if the polymer coating is conductive. The conductivity may also be achieved if the porous carbon fiber paper is bonded, welded, or embedded into and through the polymer coating in a fashion that does not violate the integrity of the coating. The conductivity may further be achieved if an intermediary support element is bonded, welded, or embedded into and through the polymer coating in a fashion that does not violate the integrity of the coating. The intermediary support element may be a screen or a series of wires. The intermediary support element may be comprised of a conductive material that is stable in the presence of the fuel cell environment, as for example carbon graphite fibers or noble metal wires, or fabrics and screens fabricated from said fibers and wires.

Conductive polymers are well established in the art. Non-conductive polymer coatings are well established in the art and are readily available in various forms. Furthermore, various methods of bonding and welding polymer structures are well established in the art. For example, a bipolar separator plate that is coated with a nonconductive polymer may be joined with the porous carbon fiber paper by means of ultrasonic welding or thermal welding. Welding is better suited to thermal-plastic non-conductive polymers.

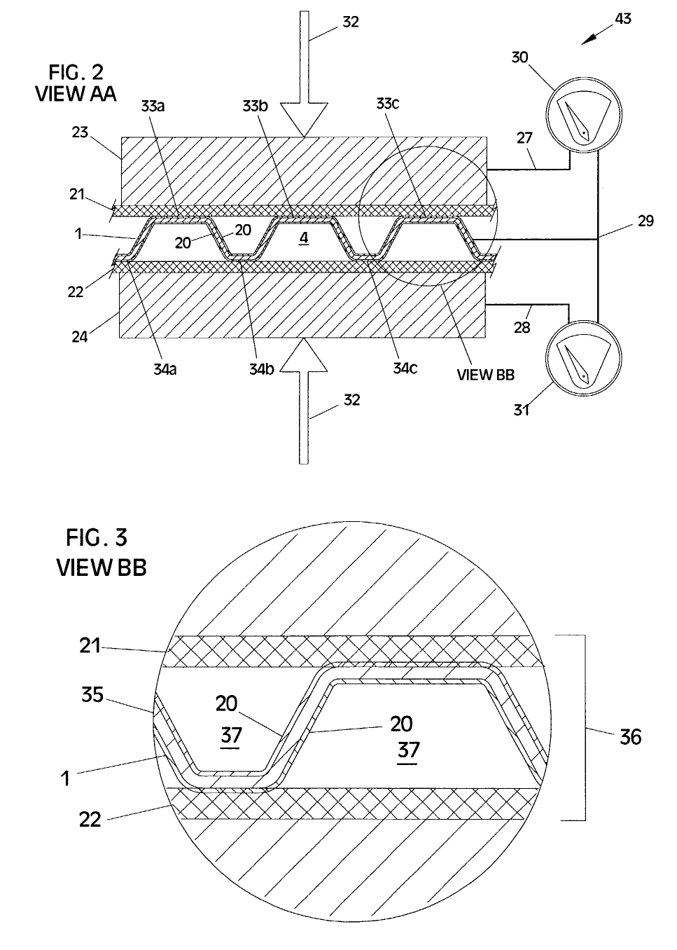

A preferred embodiment is illustrated in FIG. 2 where a bipolar separator plate 1 is shown in a cross-section taken at line AA of FIG. 1. The plate 1 has received a coating 20 comprised of a non-conductive thermal-plastic polymer. Porous carbon fiber paper current collectors 21, 22 are positioned over the central active area 4 of the plate 1. Heating platens 23, 24 are positioned over current collectors 21, 22. Platens 23, 24 are equipped with ultrasonic generators. Electrical lead 27 is provided at cathode current collector 21. Electrical lead 28 is provided at anode current collector 22. Electrical lead 29 is provided at plate 1. Electrical lead 27 from cathode current collector 21 and electrical lead 29 from plate 1 are routed to ohmmeter 30. Electrical lead 28 and electrical lead 29 are routed to ohmmeter 31. Compression device 32 is equipped to apply pressure to the assembly 32 comprising the cathode current collector 21, plate 1, and anode current collector 22.

Upon activation of the compression device 32 and ultrasonic generators heat and pressure will be generated at the interfaces 33a, 33b, 33c and 34a, 34b, 34c at the peaks of the flow channels of plate 1 and current collectors 21, 22.

Heat and pressure is applied for an amount of time necessary to result in the fibers of the porous carbon fiber current collectors 21, 22 to flow through the polymer coating 20 and contact the peaks of the flow channels of the plate 1. The welding operator may observe ohmmeters 29, 30 to determine when an optimum level of electrical conductivity is achieved at interfaces 33a, 33b, 33c and 34a, 34b, 34c.

FIG. 3 taken at View BB of FIG. 2 illustrates that the polymer coating 20 has flowed around and encapsulated the fibers of the porous carbon fiber papers comprising current collectors 21, 22. Further, it may be seen that the integrity of the polymer coating 20 is intact and that the metallic substrate 35 of the plate 1 remains encapsulated and protected from contact with the Nafion comprising the membrane 6 of an assembled cell.

Another preferred embodiment utilizes resistive heating elements within platens 23, 24. In this embodiment, heat required to perform the welding is provided from the resistive heaters. Heat is applied until the desired welded bond and the optimum ohmic resistance is achieved, at which point the resistive heaters are turned off and the welded assembly is allowed to cool.

In both aforesaid preferred embodiments cooling of the welded assembly 36 may be accelerated by the application of cooling air 37. Cooling air 37 may be applied through the inlet manifold openings 38, 39 and exhausted at outlet manifold openings 40, 41. In this manner the compression device may be released in a shorter time period after the cessation of the application of heat and the overall cycle time of the welding operation reduced.

The entire process may cycle within several seconds to yield the welded assembly 36. The welding system 42 may be equipped with automatic part feeding mechanisms to further accelerate the process cycle time.

Another preferred embodiment of the polymer coated plate 1 is the application of similar welding techniques to effect the welding and encapsulation of the eyeleted internal fuel manifold openings 39, 41.

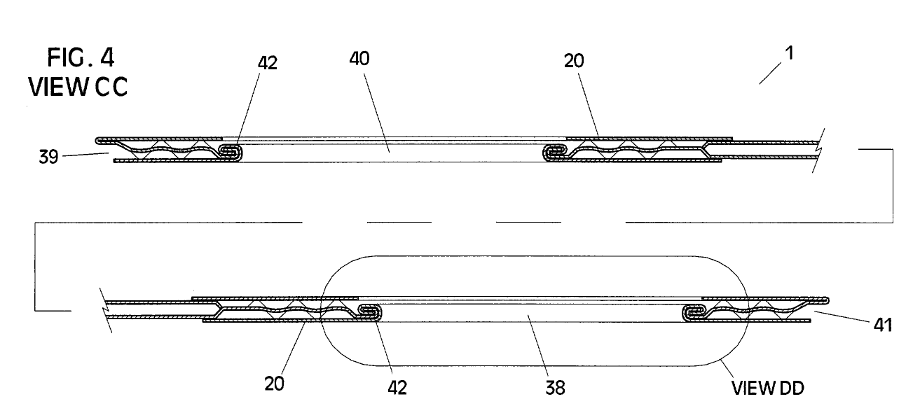

FIG. 4 illustrates a cross-section of plate 1 taken at line CC through the centerline of internal fuel manifolds 38, 40. It can be seen that the metallic foils comprising the plate 1 are joined at the periphery of the internal manifolds 38, 40 by means of an eyeleted joint 42. The sealing qualities of an eyeleted internal manifold of a plate assembled with polymer coated metallic foils may be enhanced with the application of a weld that utilizes the thermal-plastic properties of the polymer coating 20 to further encapsulate the eyeleted joint.

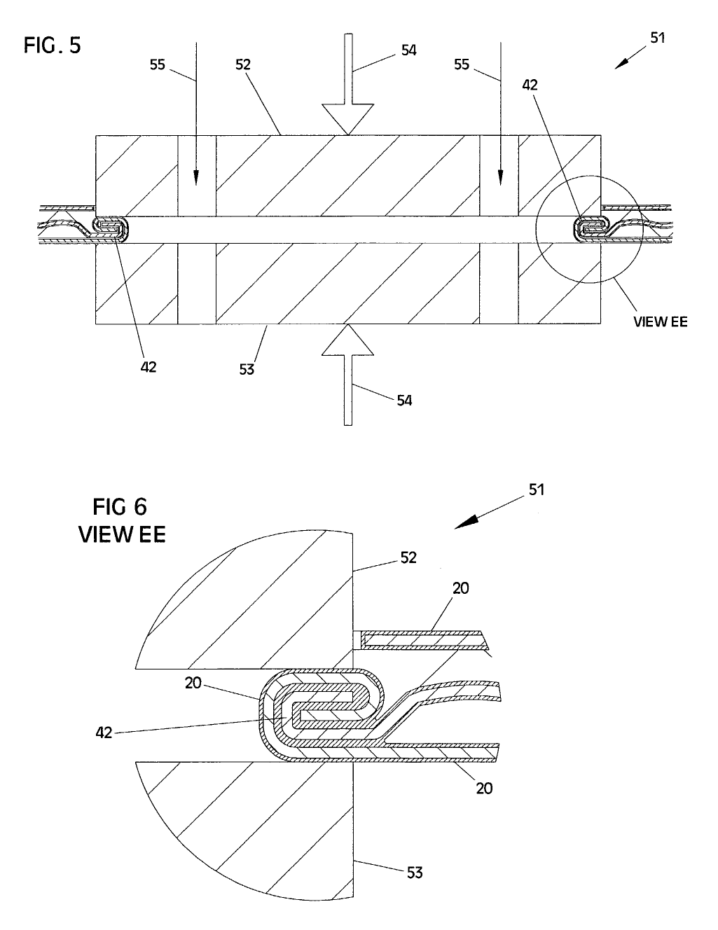

FIG. 5 illustrates a welding fixture 51 applied to the eyeleted joint 42 seen in view DD of FIG. 4. Heated platen 52 and anvil 53 apply a compressive force from compression device 54. Upon application of heat from heating platen 52 and compression from compression device 54 the thermal-plastic polymer will further encapsulate and seal the eyeleted joint 42. Cooling air 55 may be utilized to cool the welded eyeleted joint 42 upon cessation of heat and pressure. Appropriate time of heat and degree of pressure may be determined by experimentation.

FIG. 6 illustrates the enhanced encapsulated seal seen in view EE of FIG. 5 after the application of heat and pressure. It is seen that the polymer coating 20 has fused at overlapping interfaces to completely encapsulate the eyeleted seal 42.

The welding of the eyeleted joint 42 and interfaces 33a, 33b, 33c, and interfaces 34a, 34b, 34c may occur simultaneously within one single device and utilize a common source for cooling air 37, 55.

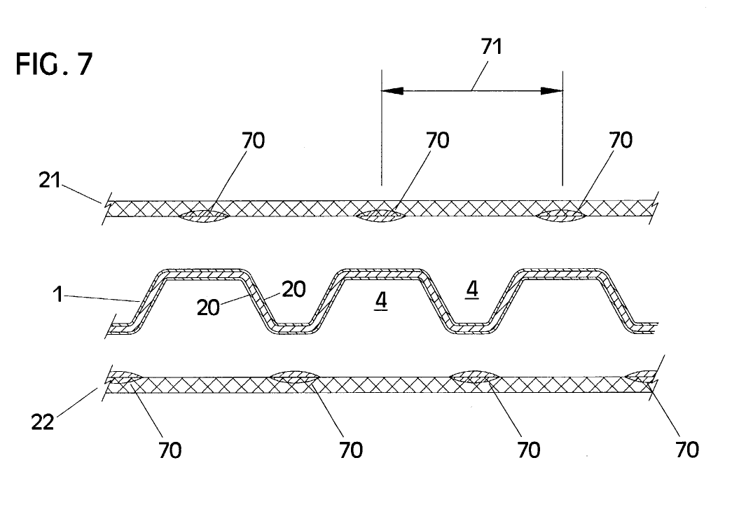

Another preferred embodiment is illustrated in FIG. 7 where the porous carbon fiber current collectors 21, 22 and the ribbed central active areas 4 of the plate 1 are shown in cross section. The current collectors 21, 22 have been pre-coated with polymer deposits 70 at intervals equal to the pitch 71 of the peaks of the flow channels. The polymer may be pre-applied to the current collectors 21, 22 using silk screening or masking or other methods to deposit the polymer only in those areas that interface with the peaks of the ribs. The areas of the current collectors 21, 22 between the intervals of polymer deposits 70 remain porous for the purpose of fuel cell reactant gas transfer to the reaction sites at the interface of the membrane 6 and electrodes. The areas of the current collectors 21, 22 with polymer deposits 70 are bonded to the peaks of the ribs at the interfaces 33, 34. The polymer deposits 70 enhance the ability of achieving an encapsulated fully conductive interface 33, 34 that avoids the contact of the metallic substrate of the plate 1 with the Nafion of the membrane 6.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

I claim:

1. A fuel cell bipolar separator plate for low temperature fuel cells utilizing proton exchange membranes, the fuel cell bipolar separator plate comprising metallic foil, wherein the foil is at least partially coated with a coating that is stable when in contact with or in close proximity to the proton exchange membrane and within the environment of the anode and cathode environments of the fuel cell.

2. The fuel cell bipolar separator plate of claim 1, wherein the foil is coated only at areas that are in intimate contact with or close proximity to the proton exchange membrane when the fuel cell bipolar separator plate is incorporated into the fuel cell.

3. The fuel cell bipolar separator plate of claim 1, wherein the foil is entirely coated with the coating.

4. The fuel cell bipolar separator plate of claim 1, wherein the coating is a conductive polymer.

5. The fuel cell bipolar separator plate of claim 1, wherein the coating is a nonconductive polymer.

6. The fuel cell of claim 1, wherein the coating is a thermal-plastic polymer.

7. The fuel cell bipolar separator plate of claim 1, wherein the coating is selected from the group consisting of a polysulphone, a polypropylene, a polyethylene and TEFLON™.

8. A fuel cell bipolar separator plate for low temperature fuel cells utilizing proton exchange membranes, wherein the foil is at least partially coated with a conductive polymer coating that is stable when in contact with or in close proximity to the proton exchange membrane and within the environment of the anode and cathode environments of the fuel cell.

9. The fuel cell bipolar separator plate of claim 8, wherein the plate is entirely coated by the coating.

10. A fuel cell comprising:
a current collector;
a proton exchange membrane; and
a fuel cell bipolar separator plate comprising metal foil that is at least partially coated with a coating that is stable when in contact with or in close proximity to the proton exchange membrane and within the environment of the anode and cathode environments of the fuel cell;
wherein the current collector is bonded, welded or embedded into and through the coating such that the current collector is in contact with the fuel cell bipolar separator plate and the integrity of the coating is not violated.

11. The fuel cell of claim 10, wherein the fuel cell bipolar separator plate is entirely coated with the coating.

12. The fuel cell of claim 10, wherein the current collector comprises porous carbon fiber paper.

13. A fuel cell comprising:
a current collector;
a proton exchange membrane;
a fuel cell bipolar separator plate comprising metal foil that is at least partially coated with a coating that is stable when in contact with or in close proximity to the proton exchange membrane and within the environment of the anode and cathode environments of the fuel cell;
an intermediary support element bonded, welded or embedded into and through the coating such that the intermediary support element is in contact with the fuel cell bipolar separator plate and the integrity of the coating is not violated.

14. The fuel cell of claim 13, wherein the intermediary support element is in contact with the current collector.

15. The fuel cell of claim 13, wherein the intermediary support element comprises a screen.

16. The fuel cell of claim 13, wherein the intermediary support element comprises a series of wires.

17. The fuel cell of claim 13, wherein the intermediary support element comprises a conductive material that is stable in the presence of the fuel cell environment.

18. The fuel cell of claim 17, wherein the intermediary support element comprises carbon graphite fibers.

19. The fuel cell of claim 17, wherein the intermediary support element comprises noble metal.

20. The fuel cell of claim 13, wherein the coating comprises a conductive polymer.

21. The fuel cell of claim 13, wherein the coating comprises a non-conductive polymer.

22. The fuel cell of claim 13, wherein the coating comprises a thermal-plastic polymer.

23. A method of manufacturing a fuel cell that utilizes a proton exchange membrane, the method comprising the steps of:
coating a fuel cell bipolar separator plate comprising an anode face and an opposing cathode face with a thermal-plastic polymer coating that is stable when in contact with or in close proximity to the proton exchange membrane and within the environment of the anode and cathode environments of the fuel cell;
positioning an anode current collector over the anode face of the fuel cell bipolar separator plate;
positioning a cathode current collector over the cathode face of the fuel cell bipolar separator plate;
compressing the current collectors into the polymer while applying heat such that the anode current collector flows into and through the polymer coating and contacts the anode face of the fuel cell bipolar separator plate and the cathode current collector flows into and through the polymer coating and contacts the cathode face of the fuel cell bipolar separator plate.

24. The method of claim 23, further comprising the step of measuring the electrical conductivity at the anode/fuel cell bipolar separator plate junction and at the cathode/fuel cell bipolar separator plate junction while compressing the current collectors into the polymer with heat.

25. The method of claim 23, wherein the compression is achieved by a compression device comprising two platens that contain resistive heating elements and wherein the current collectors are welded to the fuel cell bipolar separator plate by heat provided by the resistive heating elements.

26. The method of claim 23, wherein the fuel cell bipolar separator plate is coated with the coating by a coating method selected from the group consisting of spray coating, dip coating, roll coating, brown-film coating, cast coating and powder coating.

27. A method of manufacturing a fuel cell utilizing a proton exchange membrane, the method comprising the steps of:
providing a fuel cell bipolar separator plate comprising an anode face, an opposing cathode face and a central active area comprising a plurality of ribs comprising peaks;
providing an anode current collector and a cathode current collector;
applying deposits of a coating that is stable when in contact with or in close proximity to the proton exchange membrane and within the environment of the anode and cathode environments of the fuel cell to the current collectors at intervals equal to the peaks of the ribs of the fuel cell bipolar separator plate;
positioning the anode current collector over the anode face of the fuel cell bipolar separator plate such that the peaks of the ribs of the anode face of the fuel cell bipolar separator plate align with the coating deposits on the anode current collector;
positioning the cathode current collector over the cathode face of the fuel cell bipolar separator plate such that the peaks of the ribs of the cathode face of the fuel cell bipolar separator plate align with the coating deposits on the cathode current collector;
compressing the current collectors into the fuel cell bipolar separator plate while applying heat such that the anode current collector flows into and through the polymer coating and contacts the anode face of the fuel cell bipolar separator plate and the cathode current collector flows into and through the polymer coating and contacts the cathode face of the fuel cell bipolar separator plate.
